(19) United States
(12) Patent Application Publication
(10) Pub. No.: US 2026/0086777 A1
(43) Pub. Date: Mar. 26, 2026

(54) HIERARCHICAL DYNAMIC PLANNING OF FOUNDATION MODEL AGENTS

(71) Applicant: HUAWEI TECHNOLOGIES CO., LTD., Shenzhen (CN)

(72) Inventors: Gallaba Mudiyanselage Keheliya Bandara GALLABA, Kingston (CA); Filipe Roseiro COGO, Kingston (CA); Dayi LIN, Toronto (CA); Gopi Krishnan RAJBAHADUR, Kingston (CA); Ahmed E HASSAN, Kingston (CA)

(21) Appl. No.: 18/894,449

(22) Filed: Sep. 24, 2024

(51) Int. Cl. G06F 8/35; G06F 8/41

(52) U.S. Cl. CPC G06F 8/35; G06F 8/41

(57) ABSTRACT

Methods and system are disclosed for human-FM collaboration. The method includes acquiring an initial requirement in natural language, generating using a first FM-based agent a plan indicative of tasks and skills for achieving an objective, iteratively generating using the first FM-based agent, adjusted versions of the plan. During a given iteration, the method comprises verifying using a second FM-based agent that a current version of the plan matches the initial requirement. The method comprises compiling a latest version of the plan in an executable graph format, and providing the compiled plan for execution by a third FM-based agent. Methods and systems for plan execution are also disclosed. The method includes selecting using a fourth FM-based agent an existing agent, dynamically and automatically generating a new agent, selecting an architecture for communication between the agents, and executing the given sub-task using the selected architecture.

### FIELD

The present technology relates to planning of foundation model agents, particular to systems and methods for hierarchical dynamic planning of foundation model agents.

### BACKGROUND

Broadly speaking, a Foundation Model (FM) is a machine learning model trained in a large scale and generalist dataset and that can be adapted to perform a wide range of specialized downstream tasks. A FM application (FMware) is a software application that uses a FM as one of its building blocks.

When building Foundation Model applications (FMware) to tackle complex multi-step tasks in the real-world, the use of single Foundation Models (FMs) is reaching its limitations in terms of performance. Therefore, multi-agent systems are gaining adoption for improving performance of FMware. “Agents” in this context are FM-powered entities that can take actions to achieve goals. Broadly, agents comprise three key components: brain, perception, and action.

In an article entitled “AutoGen: Enabling Next-Gen LLM Applications via Multi-Agent Conversation”, authored by Qingyun Wu. Et al., and published on Oct. 3, 2023, there is disclosed a framework for Large Language Model (LLM) application development using multiple agents. It supports multiple inter-agent conversation patterns.

In an article entitled “Agents: An Open-source Framework for Autonomous Language Agents”, authored by Wangchunshu Zhou et al., and published on Dec. 12, 2023, there is disclosed a framework supporting planning, memory, tool usage, multi-agent communication, and symbolic control.

In an article entitled “MetaGPT: Meta Programming for A Multi-Agent Collaborative Framework”, authored by Sirui Hong et al., and published on Nov. 6, 2023, there is disclosed a framework with controllability by transforming natural language into executable action instances.

However, these known techniques do not allow granular control of the planning process of tasks based on a given objective and are ill-suited for scenarios where existing skills are not sufficient for achieving the given objective in the multi-agent environment.

### SUMMARY

The present disclosure provides methods, systems and devices for overcoming at least some drawbacks present in prior art solutions and attaining the objects set out above.

As explained above, a Foundation Model (FM) is a machine learning model trained in a large scale and generalist dataset and that can be adapted to perform a wide range of specialized downstream tasks. A FM application (FMware) is a software application that uses a FM as one of its building blocks.

However, to effectively work with multiple agents towards a complex goal, planning is required where tasks can be deconstructed into more manageable sub-tasks, coming up with appropriate sub-plans and assigning agents with relevant capabilities to each of them. This involves interactive conversations with humans to understand intentions and/or requirements, and then refining the plans

Developers have realized that, as a task progresses in FMware, it may be desirable for a multi-agent system to have a capability to introspect and dynamically modify plans and thereby adapting to environmental changes. Therefore, implementing a hierarchical dynamic planning framework for FM agents may help to efficiently and effectively use FMs in real-world scenarios.

In at least some embodiments of the present technology, there is provided methods and systems for (i) automatic verification of high-level plans, (ii) interactive hierarchical planning with human-FM collaboration, and/or (iii) FM-based automated generation of skill definitions. Developers have realized that providing one or more of the listed capabilities may facilitate users to collaboratively make high-level plans with the FM while maintaining control, and then delegate sub-tasks to be executed by groups of specialized agents autonomously.

In the context of the present technology, “multi-agent-human collaboration” refers to a paradigm for solving tasks using inter-agent-human conversations. This allows sharing of ideas, capabilities, and intermediate results across multiple agents and also with human operators, also referred to herein as “users” to achieve a common goal. This is in contrast to single-agent paradigms where specialized agents execute tasks in siloed environments.

In the context of the present technology, “hierarchical controllability with human input” refers to the ability of the FMware, depending on the impact, costs, and risks associated with each task, to provide different levels of control for respective sub-tasks. In some use cases, the users may only need final results and/or high-level steps required to achieve the objective. However, for other high-risk scenarios, the users may need additional details and control/plan all sub steps in a granularly manner. In at least some embodiments of the present technology, there is provided methods and systems that allow control of sub-tasks at a first level of granularity and at a second, lower, level of granularity.

In the context of the present technology, “dynamic planning” refers to the ability of agents to adjust the plan and decide on specific algorithms to complete the sub-asks based on changing circumstances and new information at the execution time. This functionality may be desirable as all environmental details may not be known in advance to plan all steps of a plan before starting the execution.

In some embodiments of the present technology, there is provided a “multi-agent communication” mechanism for defining multiple agents in one application and their communication. For example, since each agent is equipped with different capabilities and roles, employing multiple agents in a collaborative manner to fulfill common objectives may require capabilities that are not found in any individual agent.

In some embodiments of the present technology, there is provided a plurality of different memory types for agents (e.g., long and short term, episodic, and consensus). Based on the functionality and access needs, agents may require one or more of these different types of memory for communication and operation. In some embodiments, a first type of memory may be used for intra-group communication between agents within a same group, and a second type of memory may be used for inter-group communication between agents from different groups.

In some embodiments of the present technology, there is provided methods and systems with automated tool/skill definitions where the tools that an agent should use to perform its task are automatically defined (as opposed to manually definition). This may allow to dynamically create tools (or generate code for skills) that are not already manually added to the tool repository and or skill library by the users. This may increase the flexibility of the platform for changing requirements.

In some embodiments of the present technology, there is provided methods and systems with a plurality of different agent types. A specific implementation of an agent and its specialization may be defined. Having agents specialized for certain tasks may help with dividing up responsibilities for sub-tasks and using agents that are fine-tuned for specific tasks.

In some embodiments of the present technology, there is provided methods and systems with explicit controllability that allows explicitly control of the general behaviour of the agents with a workflow. For example, this may be achieved using Standard Operating Procedures (SOPs) and/or control flow. This means at least in a high-level plan, the users can explicitly specify the sequence of steps needed to achieve the objective(s), input formats for each sub-task and/or output formats for each sub-task.

In some embodiments of the present technology, there is provided methods and systems with an interactive planning mechanism that involves a developer to interactively design a workflow for the agents. This means the user is able to provide an initial set of requirements and request a plan of action, and may then iteratively refine a plan with the assistance of a FM. In some embodiments, during the refinement process, one or more adjusted versions of the plan may be generated by a first FM agent and verified by a second FM agent.

In some embodiments of the present technology, there is provided methods and systems that allow multi-layer controllability so as to perform interactive planning at different levels of the workflow (e.g., for a specific sub-task). This means that, for given subtasks, the users may be able to probe and control execution steps in detail, while for other subtasks only a high-level control is desired.

In some embodiments of the present technology, there is provided methods and systems with an interactive execution mechanism to interrupt agents execution and to communicate with the human operator and adjust execution based on human input. This allows to not only build applications that autonomously execute tasks to completion but also ones that seamlessly support interactions with humans. For example, the human operator may provide a human feedback in a form of one or more actions in an interface, and an FM agent may be configured to adjust a current version of the plan based on at least the human feedback.

In some embodiments of the present technology, there is provided methods and systems that allow debate and self-reflection. Developers have realized that FM agents can improve the final results by engaging in debates among one another and/or reflecting on its own responses. Therefore, developers have devised multi-agent frameworks that support agent debate or self-reflection mechanisms.

In some embodiments of the present technology, there is provided methods and systems that define a plurality of agent interaction types. This allows definition of different agent interaction implementations (e.g., peer-to-peer vs. hierarchical). For example, In peer-to-peer pattern, agents are at the same level. They negotiate, debate, and/or collaborate to achieve a final solution. In a hierarchical pattern, there are leaders and followers, where followers function based on the leaders'instructions. In a hybrid pattern, there is an interplay between different levels of hierarchy and peer-to-peer instructions. This also provides the ability for dynamic re-configuration of agent communication groups based on the task at hand.

In some embodiments of the present technology, there is provided methods and systems that perform task delegation. This means that the agents can ask/assign to do tasks by another agent. Delegation may be useful in the dynamic execution scenarios where the agents that task was assigned to for execution do not have all the required capabilities. In this case, an agent can identify other suitable agents for executing the task.

Developers have realized that known techniques do not support hierarchical controllability. Based on the impact, costs, and risks associated with each task, stakeholders may need different levels of control for subtasks. In some use cases, users may only care about the final results and/or high-level steps required to achieve the objective. In these use cases, the planning of the subtasks can be fully delegated to a foundation-model-based agent. However, for other high-risk scenarios, users may require granular low-level control and/or planning of all sub steps. At least some embodiments of the present technology may be used for scenarios where high-level and/or low-level control of the planning process of tasks is required for achieving an objective.

In a first broad aspect of the present technology, there is provided a method comprising: acquiring an initial requirement in natural language; generating, using a first FM-based agent and based on the initial requirement, a plan indicative of tasks and skills for achieving an objective; iteratively generating, using the first FM-based agent, adjusted versions of the plan, during a given iteration: verifying, using a second FM-based agent, that a current version of the plan matches the initial requirement; compiling a latest version of the plan in an executable graph format, thereby generating a compiled plan; and providing the compiled plan for execution by a third FM-based agent.

In some embodiments of the method, the iteratively providing further comprises, during the given iteration: acquiring a human feedback for adjusting a previous version of the plan, the feedback being indicative of at least one of the following actions: re-arranging at least one task in the previous version of the plan; adding at least one task to the previous version of the plan; removing at least one task from the previous version of the plan; modifying at least one task in the previous version of the plan; requesting to expand sub-tasks of at least one task in the previous version of the plan; and accepting at least a portion of the previous version of the plan; and rejecting at least a portion of the previous version of the plan; and generating, using the first FM-based agent, the current version of the plan based on at least the human feedback.

In some embodiments of the method, the iteratively providing further comprises, during the given iteration: acquiring a human approval of the current version of the plan, the current version being the latest version of the plan for compilation.

In some embodiments of the method, the initial requirement comprises an indication of Standard Operating Procedures (SOPs) and a series of steps for achieving the objective.

In some embodiments of the method, the plan comprises at least one of a textual description and a graphical representation.

In some embodiments of the method, the method further comprises generating a new agent in an agent repository by specifying skills for the new agent.

In some embodiments of the method, the method comprises selecting an existing agent in an agent repository.

In a second broad aspect of the present technology, there is provided a computer-implemented method. comprising: selecting, using a first FM-based agent, at least one existing agent available on an agent repository to execute a given sub-task in a plan based on at least one of skills of the existing agents; and complexity of the given sub-task; selecting an architecture for communication between the at least one existing agent, the selecting being based on at least one of: a problem domain, the complexity of the sub-task, and a context; and decomposing and executing the given sub-task using the selected architecture, and the at least one existing agent.

In some embodiments, the method comprises further comprises dynamically and automatically generating a new agent with generated code as a given skill, the selected architecture being for communication between the at least one existing agent and the new agent, and wherein the decomposing and the executing the given sub-task further comprises using the new agent.

In some embodiments of the method, the at least one existing agent and the new agent form a group of agents, and wherein the selecting the architecture comprises selecting for communication between the group of agents at least one of: a peer-to-peer conversion pattern architecture, a hierarchical conversion pattern architecture.

In some embodiments of the method, the decomposing and executing the given sub-task further comprises using a local scratchpad memory by the at least one existing agent and the new agent to at least one of: track intermediate results, and exchange information among the at least one existing agent and the new agent.

In some embodiments of the method, the decomposing and executing the given sub-task further comprises: using a global scratchpad memory to share data across: a first group of agents including the at least one existing agent and the new agent, and a second group of agents.

In a third broad aspect of the present technology, there is provided a computer system comprising one or more processors, and a memory storing instructions, when the instructions are executed by the one or more processors, the computer system is configured to: acquire an initial requirement in natural language; generate, using a first FM-based agent and based on the initial requirement, a plan indicative of tasks and skills for achieving an objective; iteratively generate, using the first FM-based agent, adjusted versions of the plan, during a given iteration: verify, using a second FM-based agent, that a current version of the plan matches the initial requirement; compile a latest version of the plan in an executable graph format, thereby generating a compiled plan; and provide the compiled plan for execution by a third FM-based agent.

In some embodiments of the computer system, to iteratively provide further comprises the computer system to, during the given iteration: acquire a human feedback for adjusting a previous version of the plan, the feedback being indicative of at least one of the following actions: re-arranging at least one task in the previous version of the plan; adding at least one task to the previous version of the plan; removing at least one task from the previous version of the plan; modifying at least one task in the previous version of the plan; requesting to expand sub-tasks of at least one task in the previous version of the plan; and accepting at least a portion of the previous version of the plan; and rejecting at least a portion of the previous version of the plan; and generate, using the first FM-based agent, the current version of the plan based on at least the human feedback.

In some embodiments of the computer system, to iteratively provide further comprises the computer system to, during the given iteration: acquire a human approval of the current version of the plan, the current version being the latest version of the plan for compilation.

In some embodiments of the computer system, the initial requirement comprises an indication of Standard Operating Procedures (SOPs) and a series of steps for achieving the objective.

In some embodiments of the computer system, the plan comprises at least one of a textual description and a graphical representation.

In some embodiments of the computer system, the computer system is further configured to: select, using a fourth FM-based agent, at least one existing agent available on an agent repository to execute a given sub-task in a plan based on at least one of skills of the existing agents; and complexity of the given sub-task; dynamically and automatically generate a new agent with generated code as a given skill; select an architecture for communication between the at least one existing agent, and the new agent, the selecting being based on at least one of: a problem domain, the complexity of the sub-task, and a context; and decompose and execute the given sub-task using the selected architecture, the at least one existing agent, and the new agent.

In some embodiments of the computer system, the at least one existing agent and the new agent form a group of agents, and wherein to select the architecture comprises the computer system configured to select for communication between the group of agents at least one of: a peer-to-peer conversion pattern architecture, a hierarchical conversion pattern architecture.

In some embodiments of the computer system, to decompose and execute the given sub-task further comprises the computer system configured to: use a local scratchpad memory by the at least one existing agent and the new agent to at least one of: track intermediate results, and exchange information among the at least one existing agent and the new agent.

In some embodiments of the computer system, to decompose and execute the given sub-task further comprises the computer system configured to: use a global scratchpad memory to share data across: a first group of agents including the at least one existing agent and the new agent, and a second group of agents.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a computer system according to an exemplary embodiment;

FIG. 2 illustrates a computer-implemented framework for high-level planning and plan execution performed one or more computer systems of FIG. 1 in further detail according to an exemplary embodiment; and

FIG. 3 illustrate a computer implemented method for high-level planning according to an exemplary embodiment.

FIG. 4 illustrate a computer implemented method for plan execution according to an exemplary embodiment.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

### Computer System

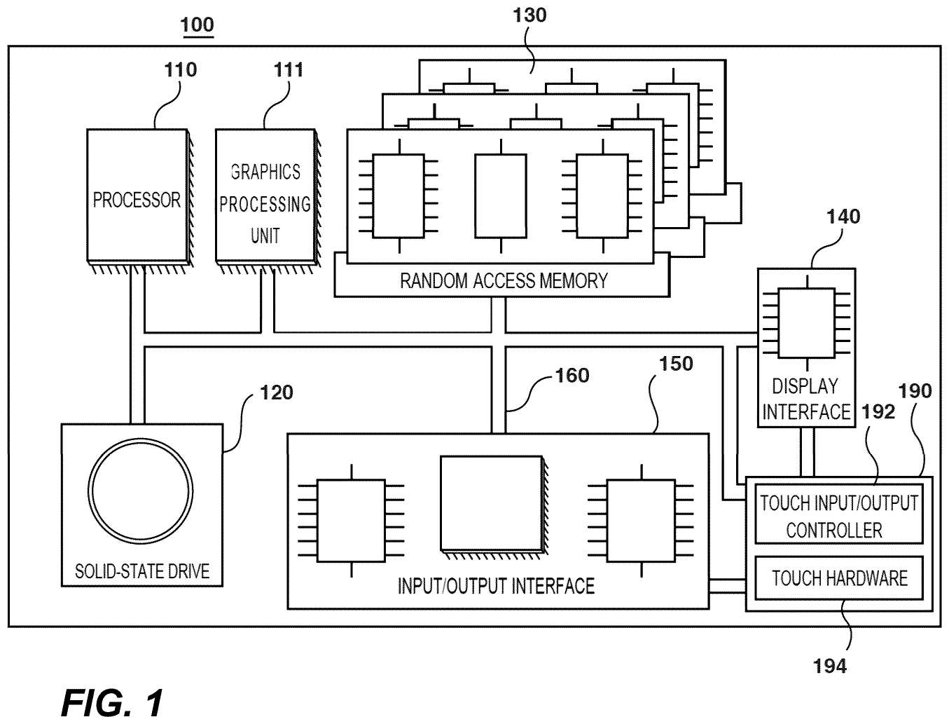

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted some components of the computer system 100 can be omitted in some non-limiting embodiments of the present technology. For example, the keyboard and the mouse (both not separately depicted) can be omitted, especially (but not limited to) where the computer system 100 is implemented as a compact electronic device.

Broadly speaking, the touchscreen 190 may comprise touch hardware 194 and a touch input/output controller 192 allowing communication with the display interface 140 and/or the one or more internal and/or external buses 160.

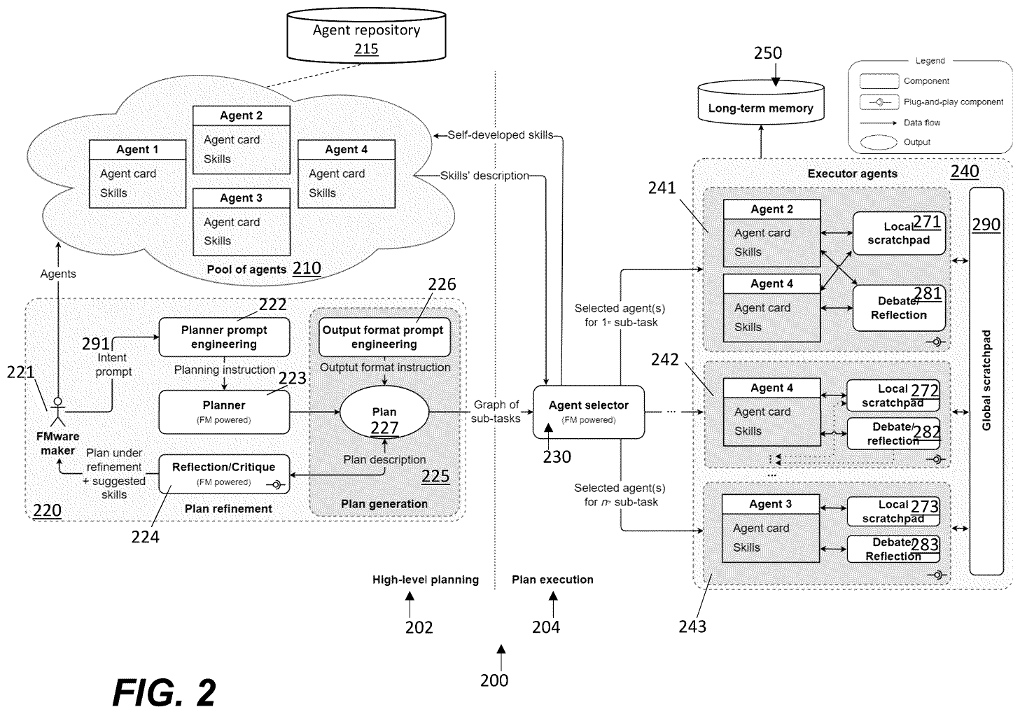

With reference to FIG. 2, there is depicted a schematic illustration of two components of a framework 200 for a hierarchical dynamic planning of FM agents. A first component 202 corresponds to a high-level planning component of the framework 200. In this embodiment, the first component 202 is configured for iterative high-level planning with human-FM collaboration. A second component 204 corresponds to a plan execution component of the framework 200. In this embodiment, the second component 202 is configured for dynamic execution of plan with groups of FM-based agents. The two components 202 and 204 will be discussed in turn.

It is contemplated that one or more components of the framework 200 may be executed by one or more computer systems. The one or more computer systems 200 executing the framework 200 may be implemented as an “off-the-shelf” computer system, and/or in a similar manner to the computer system 100, without departing from the scope of the present technology. However, the computer system 200 may be embodied differently depending on inter alia different implementations of the present technology.

### High-Level Planning Component

The first component 202 comprises a pool of agents 210. In this embodiment, the pool of agents 210 comprises four agents, each of which is associated with a respective agent card and one or more respective skills.

The first component 202 also comprises a plan refinement process 220. In this embodiment, the plan refinement process 220 is configured to generate and iteratively refine a given plan until a latest version of a plan is approved. The plan refinement process 220 comprises a plan generation process 225. In this embodiment, the plan generation process 225 is configured to generate plans and adjust a current version of a plan based on further input from a user, for example.

In the first component 202, a user 221, also referred to as a “creator of a given FM-based application”, provides an initial requirement 291 as an input in natural language. In some embodiment, the initial requirement 291 may comprise information such as Standard Operating Procedures (SOPs) to explicitly specify steps for achieving one or more objectives. The provision of the initial requirements 291 may be processed in combination with a planner prompt engineering instructions 222.

Broadly speaking, “planner prompt engineering” instructions may be embodied as one or more programming instructions for a given FM-based agent, in addition to the initial requirements 291, in order to aid the given FM-based agent to perform its function. These instructions may be agnostic to a given user, and are used by the given FM-based agent in order to process the initial requirements 291 in view of a given for the given FM-based agent.

A planner prompt engineering interface 222 may allow design and implementation of prompts within applications. These prompts serve as cues or instructions that guide users in entering essential information or making decisions relevant to their plans, tasks, or goals. The process begins with crafting prompts that are clear and intuitive, ensuring they effectively prompt users to take specific actions or provide necessary details.

In some embodiments, the user 221 can create agents into be added to the pool of agents stored in an agent repository 215. To that end, the user 221 may specify skills required by the newly-created agent for realizing an objective. Additionally or alternatively, the user 221 may re-use agents and skills already in the agent repository 215, such as public agents in the pool of agents 210.

A planner 223, embodied as a FM-powered planning agent, is configured to receive planning instructions via the planner prompt engineering interface 222 and generates a high-level plan 227 and responds to the user 221 with the high-level plan 227. The high-level plan 227 comprises a textual description and a graphical representation. It is contemplated that the textual description and the graphical representation are indicative of a breakdown of the tasks and suggested skills and/or tools to achieve the objective(s).

It is contemplated that the user 221 and the planning agent 223 may communicate, back-and-forth, for iteratively adjusting the high-level plan 227. For example, during each iteration, before an adjusted version of the plan is provided to the user 221, a given version of the plan is fed to a reflection/critique flow during which a FM-powered reflection and/or critique agent 224 verifies whether the given version of the plan matches with the user requirements 291.

It is contemplated that a given reflection agent may be implemented similarly to agents described in an article entitled “Reflexion: Language Agents with Verbal Reinforcement Learning”, authored by Noah Shinn et al., and published in 2023, the contents of which is incorporated herein by reference in is entirety.

Broadly, a reflection agent can be implemented that can receive verbal feedback in order to enhance language model performance. The method departs from traditional reinforcement learning techniques that use numerical rewards, and instead utilize human-like feedback to guide the agent's learning process. For example, that natural language feedback (such as praise, corrections, or suggestions) can provide more nuanced and contextually rich guidance than numerical values. The methodology for obtaining a reflection agent involves a two-step training process. Initially, a language model undergoes conventional training on a variety of tasks to establish a baseline performance. Once this training is complete, the model enters the reinforcement phase, where it receives feedback in the form of natural language. This feedback helps to adjust and refine the agent's behavior, enabling it to better understand and respond to human preferences and expectations.

It is contemplated that a given critique agent may be implemented similarly to agents described in an article entitled “Self-RAG: Learning to Retrieve, Generate, and Critique through Self-Reflection”, authored by Akari Asai et al., and published in 2023, the contents of which is incorporated herein by reference in is entirety.

In the Self-RAG framework, a critique agent is a component designed to enhance the quality of responses generated by the language model. After the model produces an initial output, a critique agent is configured to evaluate the response by assessing its accuracy, relevance, coherence, and/or overall effectiveness. This evaluation process involves comparing the generated response against predefined criteria and/or expected outcomes to identify any errors or areas needing improvement. The critique agent can be used as a component of the model's “self-reflection” mechanism. It provides feedback on the generated responses, highlighting issues such as factual inaccuracies and/or inconsistencies. This feedback can be employed for an iterative refinement process, where the language model uses the “critique” to make necessary adjustments and ameliorate its output. By incorporating this self-assessment capability, the model can continuously learn from its own outputs and the critique agent's evaluations. In other words, the inclusion of the critique agent in the Self-RAG framework may facilitate a dynamic feedback loop that promotes ongoing improvement. This iterative process not only helps the model generate higher-quality responses but also aids in its overall learning and performance across various language tasks.

In some embodiments, output format prompt engineering instructions 226 may be used during generation of a plan and/or an adjusted version of a plan. Broadly speaking, “output format prompt engineering” instructions may be embodied as one or more programming instructions for a given FM-based agent in order to aid the given FM-based agent to perform its function. These instructions may be agnostic to a given user and/or a given plan, and are used by the given FM-based agent in order to process data.

In at least some embodiments, the user 221 may request at least one of the following actions:
re-arranging the steps in the planned workflow by drag-and-drop;
adding/removing/modifying steps in the workflow;
requesting to expand sub-workflows; and
accepting/rejecting parts of the planned workflow via thumbs up and down.

Once the user 221 approves a latest version of the high-level plan 227, the latest version of the high-level plan 227 is compiled to an executable graph format and is sent for execution to the second component 204. Broadly speaking, the executable graph format is a structured textual representation that consists of nodes and edges which enables ordered execution using a computational process. Nodes represent tasks or operations including metadata such as input parameters, output type, and other execution semantics. Edges represent dependencies among tasks.

### Plan-Execution Component

The second component comprises an FM-powered agent selector 230. The agent selector 230 is configured to acquire output from the first component 202. For example, the agent selector 230 may acquire a graph of sub-tasks from the first component 202. The agent selector 230 is configured to select a single agent, and/or a group of agents, and to assign each for execution of respective sub-tasks proposed by the first component 202.

In order to determine candidate executor agents, the agent selector 230 is configured to take into account skills and/or tools advertised by the agents in the pool of agents 210 available in the agent repository 215, and complexity of a given sub-task at hand. For example, a given skill may be a web information retrieval functionality, a database querying functionality, a language translation functionality, an image cropping functionality, and the like. In another example, a given tool may be a calculator, a programming language compiler, and the like.

In some embodiments, if a suitable agent with relevant skills cannot be found by the agent selector 230, a new agent is automatically and dynamically created with generated code as the corresponding skill(s).

In this embodiment, the agent selector 230 is configured to request skill descriptions from the agents in the pool of agents 210. If no suitable agent is found for a given sub-task, the agent selector 230 is configured to automatically and dynamically generate a new agent to be added to the pool of agent associated with the corresponding skills for that sub-task.

In this embodiment, the selector agent 230 is configured to determine executor agents 240. For example, the selector agent 230 may determine a group of executor agents 241 for a first sub-task, an executor agent 242 for a second sub-task, and an executor agent 243 for a nth sub-task. The first group of executor agents 241 comprises the agent 2 and the agent 4. In one embodiment, the agent 4 may be generated following user input provided in first component 202. In another embodiment, the agent 4 may be automatically and dynamically generated by the agent selector 230. In a third embodiment, the agent 4 may be an existing agent from the pool of agents 210, such as a public agent, for example.

At runtime, a cognitive architecture will be chosen for decomposing and executing a given sub-task based on at least one of: a problem domain, task complexity, and context. For example, in the case of single agent execution (such as the executor agent 242 for the second sub-task or the executor agent 243 for the nth sub-task), one of the following architectures may be selected: chain-of-thought, tree-of-thought, graph-of-thought, or rationale-augmented ensembles. Similarly, for tasks assigned for multi-agent groups, such as the group of executor agents 241, a suitable architecture for conversation pattern may be selected, such as peer-to-peer or hierarchical, for example, to communicate among the executor agents within the group 241.

It is contemplated that one or more of at least three types of memory and/or storage may be used during the execution phase.

A local scratchpad memory may be used by one or more agents to track intermediate results (generated by themselves) and/or exchange ideas among agents in the same group during the execution of a sub-task. The local scratchpad memory for a particular task is temporary and is deleted after the completion of the sub-task. For example, the first group of executor agents 241 may use a local scratchpad memory 271, the executor agent 242 may use a local scratchpad memory 272, and the executor agent 243 may use a local scratchpad memory 273.

A global scratchpad memory may be used to share data across agent groups (or single agents) in sub-tasks. Developers have realized that such as memory may be useful in situations where the results from the previous sub-tasks in a given plan may inform reasoning and/or problem solving in subsequent sub-tasks. The global scratchpad is deleted after the completion of the overall plan. For example, a global scratchpad memory 290 may be used to communicate between (i) the group of executor agents 241 for the first sub-task, (ii) the executor agent 242 for the second sub-task, and (iii) the executor agent 243 for the nth sub-task.

A long-term storage may be used to store historical data, such as conversation history, outcome of plan executions, and the like. For example, a long-term memory 250 may be employed for storing a variety of data from the plurality of executor agents 240.

The group of executor agents 241 for the first sub-task may be configured to employ a debate and/or reflection agent as an agent 281, the executor agent 242 for the second sub-task may be configured to employ a debate and/or reflection agent as an agent 282, and (iii) the executor agent 243 for the nth sub-task may be configured to employ a debate and/or reflection agent as an agent 283. The agents 281, 282, and 283 may be employed for performing debate and/or reflection mechanisms for respective executor agents.

It is contemplated that a given debate agent may be implemented similarly to agents described in an article entitled “Encouraging divergent thinking in large language models through multi-agent debate”, authored by T. Liang et al., and published in 2023, the contents of which is incorporated herein by reference in is entirety.

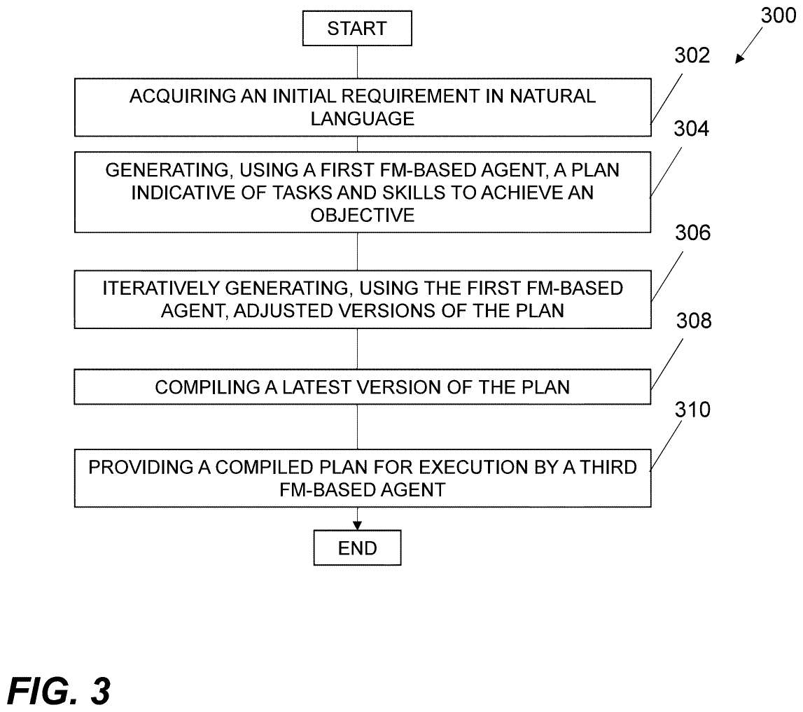

With reference to FIG. 3, there is depicted a scheme-block illustration of a method 300 executable by one or more computer systems.

At step 302, the computer system 100 is configured to acquire an initial requirement in natural language. For example, the computer system 100 may acquire the initial requirement 291 from the user 221. The initial requirement may comprise an indication of SOPs and a series of steps for achieving the objective. At least some non-limiting examples of the initial requirement may be “Create a website to publicize my event”, “I want to build an app to track scores of my favorite sports team every day”, “I want a script to receive tech news everyday to my inbox”, “Make a plan and execute it to fix this bug in this source code repository”, and the like.

It is contemplated the computer system 100 may acquire an indicator from the user 221 regarding her/his selection of an existing agent in the agent repository 215. In other embodiments, the computer system 100 may acquire an indication form the user 221 specifying skills for generating a new agent to be added to the pool of agents 210.

At step 304, the computer system 100 is configured to generate, using a first FM-based agent, a plan indicative of tasks and skills to achieve an objective. For example, the computer system 100 may generate the plan 227 using the planner 223. It is contemplated that the plan 227 may comprise at least one of a textual description and a graphical representation.

In one scenario, let it be assumed that the initial requirement is to “Create a website to publicize my product.”. In this scenario, the initial high-level plan may comprise the following sub-tasks: (1) Website textual content generation (2) Website graphical content generation (3) Front-end code generation (4) Backend code generation. Then, execution of 1^{st} sub-task (i.e., textual content generation) may be delegated to a set of agents that has natural-language skills such as copy writing, grammar correction, spelling correction, for example. By using the critique/debate mechanism(s), these agents may iterate over the task and produce the textual content, which will be fed into the subsequent sub tasks to the 1^{st} sub-task. Similarly, 3^{rd} sub-task may be executed by a group of agents specialized in generating source code in front-end technologies such as HTML, CSS, and JavaScript, for example.

At step 306, the computer system 100 is configured to iteratively generate, using the first FM-based agent, adjusted versions of the plan. For example, the computer system 100 may execute a plan refinement process 220. During the plan refinement process 220, the computer system 100 may be configured to generate a plurality of adjusted versions of the plan 227. During a given iteration of the refinement process 220, the computer system 100 may be configured to verify, using the reflection/critique agent 224, that a current version of the plan 226 matches the initial requirement 291.

In some embodiments, during a given iteration, the computer system 100 may be configured to acquire a human feedback from the user 221 for adjusting a most recent version of the plan 227 presented to the user 221. The human feedback can be indicative of at least one of the following actions: re-arranging at least one task in the previous version of the plan 227, adding at least one task to the most recent version of the plan 227, removing at least one task from the most recent version of the plan 227, modifying at least one task in the most recent version of the plan 227, requesting to expand sub-tasks of at least one task in the most recent version of the plan 227, accepting at least a portion of the most recent version of the plan 227, and rejecting at least a portion of the most recent version of the plan 227. The computer system 100 may also be configured to generate, using the planner 223, a now-new version of the plan 227 based on at least the human feedback. For example, during step 306, the user may provide feedback indicative of the importance of quality assurance. In response, the FM-based agent may be configured to generate an additional step referred to as “end user testing”, for example, to the initial plan to accommodate the user suggestion of adding quality assurance to the plan.

In other embodiments, during a given iteration the computer system 100 may be configured to acquire a human approval from the user 221 of the most current version of the plan 227.

It is contemplated that the computer system 100 is configured to iteratively generate adjusted versions of the plan, as opposed to generating new plans. It is also contemplated that an existing plan may be adjusted using the computer system 100. In at least some embodiments, more than one previous versions of the plan in the iterative process may be used by the computer system 100 for generating a most recent version of the plan during current iteration of the iterative process.

At step 308, the computer system 100 is configured to compile a latest version of the plan. Broadly speaking, the compilation process is performed by providing instructions to a FM-based agent via a system prompt. The so-provided instructions may include the original user requirement (e.g., from the step 302), subsequent conversation information which involved the user (e.g., from the step 306), intermediate high-level plans (e.g., generated at the step 304 and the step 306), and other constraints to for the compiliation of the plan such as the output format, for example. At step 310, the computer system 100 is configured to provide a compiled plan for execution by a third FM-based agent. For example, the computer system 100 may be configured to provide the compiled plan (comprising a graph of sub-tasks) to the agent selector 230.

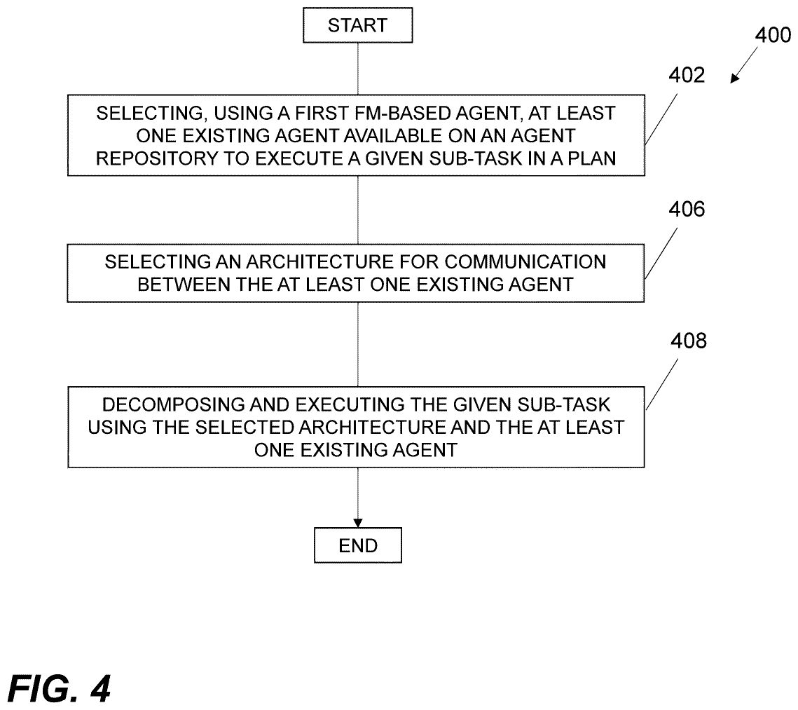

With reference to FIG. 4, there is depicted a scheme-block illustration of a method 400 executable by one or more computer systems.

It should be noted that, given the user requests a task of ‘website creation’ and the high-level plan containing five steps, namely: (1) Website textual content generation (2) Website graphical content generation (3) Front-end code generation (4) Backend code generation and (5) End-user testing, at least some steps of the method 400 (such as steps 402 and 406, for example) may allow annotating the plan with metadata required to execute the plan in an other step of the method 400 (such as a step 408, for example). What type of metadata may be generated and added to the plan will be described in greater details herein further below.

At step 402, the computer system 100 is configured to select, using a first FM-based agent, at least one existing agent available on an agent repository to execute a given sub-task in a plan. For example, the computer system 100 may be configured to selected, using the agent selector 230, a first executor agent from the pool of agents 215 based on skills of the existing agents in the pool of agents 215, and complexity of the given sub-task.

In step 402, each plan step may be annotated to have a ‘cardinality’ field which can have values such as ‘single’ or ‘multi’, for example. This operation may allow to distinguish between whether the step is executed by a single agent, or otherwise a group of agents. Then, the ‘candidate agents’ field may be populated based on the available FM-based agents in a given pool of agents. For example, ‘Backend code generation’ plan step described above may comprise one or more of the following fields:
Step: Backend code generation;
Cardinality: Multi; and
Candidate Agents: Architect Agent, Developer Agent, Code Reviewer Agent.

In some cases, the agent selector 230 may not find a suitable agent (or agents) in the pool of agents for a given sub-task.

In some embodiments, the computer system 100 may be configured to dynamically and automatically generate a new agent with generated code as a given skill. In some cases, the agent selector 230 may not find a suitable agent or agents in the pool of agents for a given sub-task. In these cases, the agent selector 230 may be configured to automatically and dynamically generate a new agent for execution by generating code for required skills. This new agent may also be added to the pool of agents 210.

At step 406, the computer system 100 is configured to select an architecture for communication between the at least one existing agent. For example, the computer system 100 may be configured to select a given architecture based on at least one of: a problem domain, the complexity of the sub-task, and a context.

For example, the group of executor agents 241 may comprise an existing agent from the pool of agents 210 and a new agent automatically and dynamically generated by the agent selector 230. In this example, the computer system 100 may select at least one of: a peer-to-peer conversation pattern architecture, a hierarchical conversation pattern architecture.

It should be noted that in some scenarios, such as for the ‘Back end code generation’ plan step, the communication pattern may be selected as Round-robin communication pattern.

At step 408, the computer system 100 is configured to decompose and execute the given sub-task using the selected architecture, the at least one existing agent, and the new agent.

For example, for the ‘Back end code generation’ step, since the ‘Round robin’ communication pattern has been selected, the candidate agents will be called upon to perform their respective task(s) in a fixed and/or pre-determined sequence (e.g., Architect−>Developer−>Code Reviewer) and generate corresponding output(s). In one non-limiting example, the following sequence may be executed:
i. Architect agent may acquire the requirements and text generated from the previous high-level step and generate a backend architecture document;
ii. Next, the developer agent may generate the backend code based on the backend architecture document provided by the architect agent;
iii. Next, the code review agent may inspect the code generated by the developer agent and provide a list of comments with respect to software engineering aspects such as functionality, performance, security, and maintenance, for example;
iv. This sequence of events may be repeated (e.g., iteratively) until all comments from the architect and code review agent are addressed by the developer agent; and
v. The output generated by this step (i.e., backend source code) may be provided to the subsequent high-level step (i.e., End user testing).

In some embodiments, the computer system 100 may be configured to use the local scratchpad memory 271 by the group of executor agents 241 to at least one of: track intermediate results, and exchange information among the group of executor agents 241.

In other embodiments, the computer system 100 may be configured to use the global scratchpad memory 290 to share data across: the group of executor agents 241 and a second group of agents, and/or another single executor agent such as the executor agent 242 and/or the executor agent 243.

In at least some embodiments of the present technology, the computer system 100 may be configured to execute one or more steps from the method 300, followed by one or more steps from the method 400, without departing from the scope of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method, comprising:
acquiring an initial requirement in natural language;
generating, using a first FM-based agent and based on the initial requirement, a plan indicative of tasks and skills for achieving an objective;
iteratively generating, using the first FM-based agent, adjusted versions of the plan,
during a given iteration:
verifying, using a second FM-based agent, that a current version of the plan matches the initial requirement;
compiling a latest version of the plan in an executable graph format, thereby generating a compiled plan; and
providing the compiled plan for execution by a third FM-based agent.

2. The method of claim 1, wherein the iteratively providing further comprises, during the given iteration:
acquiring a human feedback for adjusting a previous version of the plan, the feedback being indicative of at least one of the following actions:
re-arranging at least one task in the previous version of the plan;
adding at least one task to the previous version of the plan;
removing at least one task from the previous version of the plan;
modifying at least one task in the previous version of the plan;
requesting to expand sub-tasks of at least one task in the previous version of the plan; and
accepting at least a portion of the previous version of the plan; and
rejecting at least a portion of the previous version of the plan; and
generating, using the first FM-based agent, the current version of the plan based on at least the human feedback.

3. The method of claim 1, wherein the iteratively providing further comprises, during the given iteration:
acquiring a human approval of the current version of the plan, the current version being the latest version of the plan for compilation.

4. The method of claim 1, wherein the initial requirement comprises an indication of Standard Operating Procedures (SOPs) and a series of steps for achieving the objective.

5. The method of claim 1, wherein the plan comprises at least one of a textual description and a graphical representation.

6. The method of claim 1, wherein the method further comprises generating a new agent in an agent repository by specifying skills for the new agent.

7. The method of claim 1, wherein the method comprises selecting an existing agent in an agent repository.

8. A computer-implemented method, comprising:
selecting, using a first FM-based agent, at least one existing agent available on an agent repository to execute a given sub-task in a plan based on at least one of skills of the existing agents, and complexity of the given sub-task;
selecting an architecture for communication between the at least one existing agent, the selecting being based on at least one of: a problem domain, the complexity of the sub-task, and a context; and
decomposing and executing the given sub-task using the selected architecture and the at least one existing agent.

9. The method of claim 8, wherein the method comprises further comprises dynamically and automatically generating a new agent with generated code as a given skill, the selected architecture being for communication between the at least one existing agent and the new agent, and wherein the decomposing and the executing the given sub-task further comprises using the new agent.

10. The method of claim 9, wherein the at least one existing agent and the new agent form a group of agents, and wherein the selecting the architecture comprises selecting for communication between the group of agents at least one of: a peer-to-peer conversion pattern architecture, a hierarchical conversion pattern architecture.

11. The method of claim 9, wherein the decomposing and executing the given sub-task further comprises:
using a local memory by the at least one existing agent and the new agent to at least one of: track intermediate results, and exchange information among the at least one existing agent and the new agent.

12. The method of claim 9, the decomposing and executing the given sub-task further comprises:
using a global memory to share data across: a first group of agents including the at least one existing agent and the new agent, and a second group of agents.

13. A computer system comprising one or more processors, and a memory storing instructions, when the instructions are executed by the one or more processors, the computer system is configured to:
acquire an initial requirement in natural language;
generate, using a first FM-based agent and based on the initial requirement, a plan indicative of tasks and skills for achieving an objective;
iteratively generate, using the first FM-based agent, adjusted versions of the plan,
during a given iteration:
verify, using a second FM-based agent, that a current version of the plan matches the initial requirement;
compile a latest version of the plan in an executable graph format, thereby generating a compiled plan; and
provide the compiled plan for execution by a third FM-based agent.

14. The computer system of claim 13, wherein to iteratively provide further comprises the computer system to, during the given iteration:
acquire a human feedback for adjusting a previous version of the plan, the feedback being indicative of at least one of the following actions:
re-arranging at least one task in the previous version of the plan;
adding at least one task to the previous version of the plan;
removing at least one task from the previous version of the plan;
modifying at least one task in the previous version of the plan;
requesting to expand sub-tasks of at least one task in the previous version of the plan; and
accepting at least a portion of the previous version of the plan; and
rejecting at least a portion of the previous version of the plan; and
generate, using the first FM-based agent, the current version of the plan based on at least the human feedback.

15. The computer system of claim 13, wherein to iteratively provide further comprises the computer system to, during the given iteration:
acquire a human approval of the current version of the plan, the current version being the latest version of the plan for compilation.

16. The computer system of claim 13, wherein the initial requirement comprises an indication of Standard Operating Procedures (SOPs) and a series of steps for achieving the objective.

17. The computer system of claim 13, wherein the plan comprises at least one of a textual description and a graphical representation.

18. The computer system of claim 13, wherein the computer system is further configured to:
select, using a fourth FM-based agent, at least one existing agent available on an agent repository to execute a given sub-task in a plan based on at least one of skills of the existing agents, and complexity of the given sub-task;
dynamically and automatically generate a new agent with generated code as a given skill;
select an architecture for communication between the at least one existing agent, and the new agent, the selecting being based on at least one of: a problem domain, the complexity of the sub-task, and a context; and
decompose and execute the given sub-task using the selected architecture, the at least one existing agent, and the new agent.

19. The computer system of claim 18, wherein the at least one existing agent and the new agent form a group of agents, and wherein to select the architecture comprises the computer system configured to select for communication between the group of agents at least one of: a peer-to-peer conversion pattern architecture, a hierarchical conversion pattern architecture.

20. The computer system of claim 18, wherein to decompose and execute the given sub-task further comprises the computer system configured to:
use a local scratchpad memory by the at least one existing agent and the new agent to at least one of: track intermediate results, and exchange information among the at least one existing agent and the new agent.

21. The computer system of claim 18, wherein to decompose and execute the given sub-task further comprises the computer system configured to:
use a global scratchpad memory to share data across: a first group of agents including the at least one existing agent and the new agent, and a second group of agents.
